(19) United States
(12) Patent Application Publication
(10) Pub. No.: US 2012/0229471 A1
(43) Pub. Date: Sep. 13, 2012

(54) DRAWING SYSTEM

(75) Inventor: Toshihiro TAKAI, Aichi (JP)

(73) Assignee: Elmo Co., Ltd., Nagoya-shi (JP)

(21) Appl. No.: 13/401,912

(22) Filed: Feb. 22, 2012

(30) Foreign Application Priority Data
Mar. 7, 2011 (JP) 2011-048593

(51) Int. Cl. G06T 11/20; G06F 3/033

(52) U.S. Cl. 345/443; 345/157

(57) ABSTRACT

A drawing system includes a pointing device, a control unit and a drawing unit drawing a line of trajectory of the cursor and including a straight line input assisting unit. The assisting unit includes a start point recognizing unit, an end point determination unit and a coordinate aligning unit. The start point recognizing unit recognizes as a start point an initial coordinate having an input position designated by the coordinate input unit. The end point determination unit determines as an end point a last coordinate having an input position designated by the coordinate input unit. The coordinate aligning unit aligns the coordinates of the primary coordinate group on a single line connecting between the start and end points thereby to form a secondary coordinate group. When a line is drawn based on the primary coordinate group, the line is corrected to a straight line based on the secondary coordinate group.

### CROSS-REFERENCE TO RELATED APPLICATIONS

This application is based upon and claims the benefit of priority from the prior Japanese Patent Application No. 2011-048593 filed on Mar. 7, 2011, the entire contents of which are incorporated herein by reference.

### BACKGROUND

1. Technical Field

The present disclosure relates to a drawing system in which a plurality of coordinates on a monitor screen is continuously designated using a pointing device which designates position coordinate of a cursor displayed on the monitor screen, thereby drawing a trajectory of the cursor as line.

2. Related Art

Terminal devices such as personal computers or tablet-type portable terminals are provided with an input device such as keyboard or pointing device. The pointing device called “mouse” or “tablet” includes a coordinate input unit which designates an input position and coordinate on a screen of a monitor. The input position or current position coordinate each input by the coordinate input unit is displayed on the monitor screen as a cursor which is a pictorial symbol or icon.

A drawing system constituted by a terminal device, a pointing device and a monitor includes a drawing unit which executes drawing on the monitor screen using the pointing device as an ink brush or pen. The drawing unit is configured to draw a trajectory of the cursor as line on the monitor screen when a plurality of coordinates is continuously designated by the pointing device.

A conventional drawing unit includes a free line forming unit which is capable of drawing freehand and a straight line forming unit which is specialized to draw a straight line on the display screen. The straight line forming unit is configured to draw a straight line while a specific key of the keyboard is being depressed. Alternatively, the straight line forming unit is configured to draw a straight line by designating a start point and an end point and to further connect the two points together thereby to change the setting after having designated a drawing pattern called “icon” indicative of a function of drawing a straight line on the monitor screen with the use of the pointing device. Consequently, a straight line can be displayed on the monitor screen.

However, the above-described straight line forming unit necessitates changing the setting when a straight line is formed. Accordingly, the straight line forming unit requires troublesome work and is inconvenient when the straight line forming unit and the free line forming unit need to be frequently changed therebetween. For example, this can be encountered when characters and numeric expressions both written free hand in many cases and a graph or graphic chart based on the numeric expressions are displayed and the relationship is shown by a straight line, lead line including the straight line and the like.

### SUMMARY

Therefore, an object of the disclosure is to provide a drawing system which can draw a straight line without troublesome work, thereby improving the usability thereof.

The present disclosure provides a drawing system comprising a monitor; a pointing device including a coordinate input unit which designates an input position or a coordinate on a screen of the monitor or moves a cursor displayed on the monitor screen to an optional position; a control unit which controls the pointing device and the cursor so that a moving distance and a direction of the pointing device and a moving distance and a direction of the cursor are associated with each other; a drawing unit which draws a line of a trajectory of the cursor on the monitor screen, based on a group of primary coordinates formed by aligning a plurality of coordinates continuously input by the coordinate input unit, wherein the drawing unit includes a straight line input assisting unit which corrects a line formed based on the primary coordinate group to a straight line; the straight line input assisting unit includes a start point recognizing unit, an end point determination unit and a coordinate aligning unit; the start point recognizing unit recognizes as a start point an initial coordinate having an input position designated by the coordinate input unit; the end point determination unit determines as an end point a last coordinate having an input position designated by the coordinate input unit; the coordinate aligning unit aligns the coordinates of the primary coordinate group on a single line connecting between the start point and the end point thereby to form a secondary coordinate group; and when a line is drawn by the drawing unit based on the primary coordinate group, the line is corrected to a straight line based on the secondary coordinate group.

According to the above-described system, when the start point recognizing unit recognizes as a start point an initial coordinate having an input position designated by the coordinate input unit and the end point determination unit determines as an end point a last coordinate having an input position designated by the coordinate input unit, the coordinate aligning unit aligns the coordinates of the primary coordinate group on a single line connecting between the start point and the end point thereby to form a secondary coordinate group;

Thus, the line based on the primary coordinate group comprising the initially input plural coordinates is corrected to the straight line based on the secondary coordinate group. Accordingly, the straight line can automatically be formed without change of the setting by depressing a specific key on the keyboard or designating the icon for the straight line forming function displayed on the monitor screen by the pointing device. Consequently, since the straight line is drawn without any troublesome work, the usability of the drawing system can be improved.

### BRIEF DESCRIPTION OF THE DRAWINGS

In the accompanying drawings:

FIG. 1 schematically illustrates devices constituting a drawing system according to an embodiment;

FIG. 2 is a schematic block diagram showing an electrical arrangement of a terminal device used with the drawing system;

FIG. 3 is a schematic block diagram showing an electrical arrangement of the drawing system;

FIG. 4 is a flowchart showing the processing to correct signals of primary coordinate group to signals of secondary coordinate group by the drawing system;

FIGS. 5A and 5B are schematic diagrams showing correction of the line based on the primary coordinate group to a straight line based on the secondary coordinate group by the drawing system;

FIGS. 6A and 6B schematically illustrate an informing manner executed before the line based on the primary coordinate group is corrected to the straight line based on the secondary coordinate group by the drawing system;

FIGS. 7A and 7B schematically illustrate an informing manner executed after the line based on the primary coordinate group has been corrected to the straight line based on the secondary coordinate group by the drawing system;

FIG. 8 shows changes in the straight line based on the secondary coordinate group in the drawing system with lapse of time;

FIGS. 9A and 9B show the straight line based on the secondary coordinate group in the drawing system, the straight line being rendered selectable after lapse of a predetermined time;

FIGS. 10A and 10B show the straight line based on the secondary coordinate group, the straight line changing due to changes in the depressing force applied to the coordinate input screen; and

FIGS. 11A and 11B show the straight line based on the secondary coordinate group and changing according to an inclination of a stylus pen.

### DETAILED DESCRIPTION

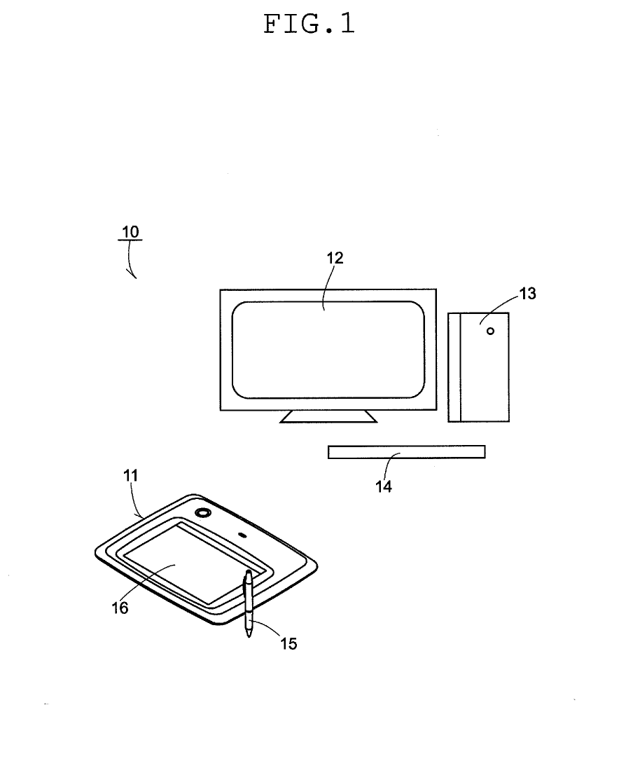

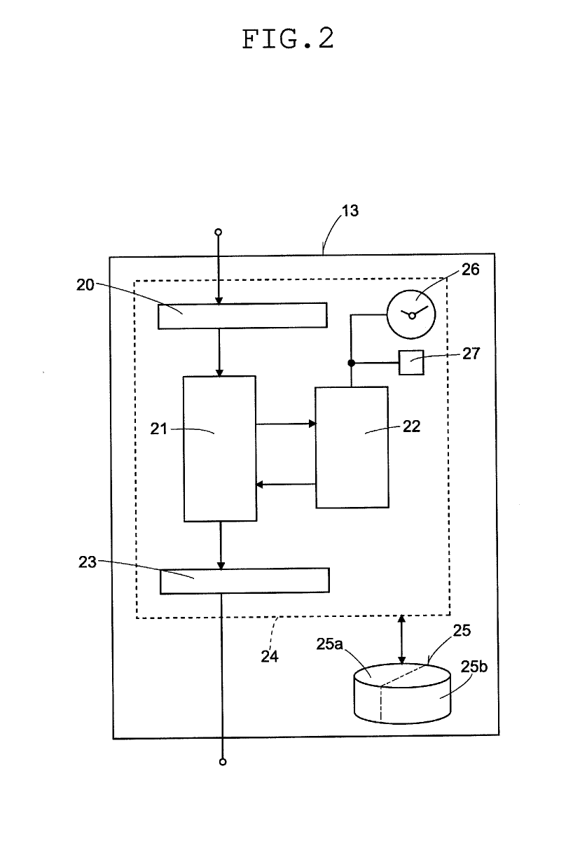

A first embodiment will be described with reference to the accompanying drawings. Referring to FIG. 1, devices composing the drawing system are shown. FIG. 2 shows a schematic arrangement of the drawing system according to the embodiment.

The drawing system 10 includes a tablet 11, a monitor 12 and a terminal device 13 as shown in FIG. 1. The drawing system 10 may preferably include a keyboard 14. The tablet 11 is one of input devices called “pointing device.” The pointing device is an input device which indicates an input position and a coordinate on a screen of the monitor 12. The pointing device includes a mouse, track pad and track ball and detects a moving direction and a moving speed of one input position to relatively designate another input position which has been input after the one input position. The pointing device also includes a touch panel, touch screen, tablet and digitizer each of which associates a coordinate input screen formed into a planar shape with a screen of the monitor 12 in a one-to-one relation, thereby absolutely designating an input position.

The stylus pen 15 is a pen-type input assisting device. The tablet 11 includes a coordinate input unit provided with a coordinate input plane 16. When the coordinate input plane 16 is depressed by a tip of the stylus pen 15, the coordinate input unit outputs a signal indicative of a coordinate of an input position designated by the pen tip. When the tip of the stylus pen 15 is moved away from the coordinate input plane 16, the coordinate input unit stops signal output. Alternatively, the coordinate input plane 16 may be depressed by a finger tip, instead of the stylus pen 15.

The tablet 11 and the terminal device 13 are connected together by radio. However, the tablet 11 and the terminal device 13 may be wired, instead. The signal indicative of the coordinate of the input position input by the stylus pen 15 is supplied via the terminal device 13 into the monitor 12. A cursor is displayed at the coordinate corresponding to the coordinate on the coordinate input plane 16 on a screen of the monitor 12.

The terminal device 13 includes a control section 24 provided with an input section 20, a drawing section 21, a correction processing section 22 and an output section 23, and an external recording medium 25, as shown in FIG. 2. The signal indicative of the coordinate of the input position on the coordinate input plane 16 supplied from the tablet 11 are further supplied into the input section 20. These signals are still further supplied to the drawing section 21. The drawing section 21 successively records or stores the signals supplied from the input section 20, thereby forming a primary coordinate group comprising a plurality of coordinates. Signals indicative of the primary coordinate group are supplied via the output section 23 to the monitor 12.

When the coordinates contained in the primary coordinate group are aligned, the drawing section 21 connects the coordinates thereby to draw a line based on the primary coordinate group. The line drawn by the drawing section 21 is supplied via the output section 23 to the monitor 12. Thus, the line based on the primary coordinate group can be displayed on the monitor 12 without passing through the correction processing section 22. Furthermore, the signals indicative of the line based on the primary coordinate group are branched at the drawing section 21 to be supplied into the correction processing section 22. The correction processing section 22 is configured to correct the signals indicative of the primary coordinate group input to the drawing section 21 to automatically covert to signals indicative of a secondary coordinate group. The secondary coordinate group obtained by correcting the line based on the primary coordinate group forms a straight line. Thus, the line based on the primary coordinate group freely input from the tablet 11 is automatically corrected to the straight line based on the secondary coordinate group.

The drawing section 21 and the correction processing section 22 are configured to be capable of two-way communication of the signals indicative of coordinates. As a result, signals indicative of the line based on the primary coordinate group and signals indicative of the straight line based on the secondary coordinate group are freely transmissible between the drawing section 21 and the correction processing section 22. Consequently, a line can quickly be corrected to a straight line, and the corrected straight line can easily be returned to the pre-processing line. The output section 23 is configured to supply to the monitor 12 the line based on the primary coordinate group or the straight line which is based on the secondary coordinate group and has been corrected by the correction processing section 22, either one selected by the user using the drawing section 21.

In addition to the above-described configuration, the control section 24 includes a control unit which controls a coordinate indicative of a predetermined position on the coordinate input screen 16 of the tablet 11 and a coordinate indicative of a predetermined position on the screen of the monitor 12 so that both coordinates absolutely correspond one-to-one with each other. As a result, the coordinate of the input position designated on the coordinate input screen 16 can accurately be reflected on the screen of the monitor 12. In this case, a small image or figure called “cursor” is displayed at the input position on the screen of the monitor 12.

The external recording medium 25 includes a pre-correction state memory area 25a and a post-correction state memory area 25b. The pre-correction state memory area 25a records or stores information about signals indicative of the line based on the primary coordinate group supplied to the drawing section 21. The post-correction state memory area 25b records or stores information about signals indicative of the straight line which is based on the secondary coordinate group and has been corrected by the correction processing section 22.

The drawing system 10 having the above-described configuration corrects coordinates contained in the primary coordinate group freely supplied from the tablet 11 so that the coordinates are aligned on a single straight line, thereby forming the straight line based on the secondary coordinate group. A correcting manner will now be described with reference to the accompanying drawings. The drawing section 21 includes a drawing unit 100, and the correction processing section 22 includes a straight line input assisting unit 130. The drawing unit 100 includes a free line forming unit 110 and a straight line forming unit 120.

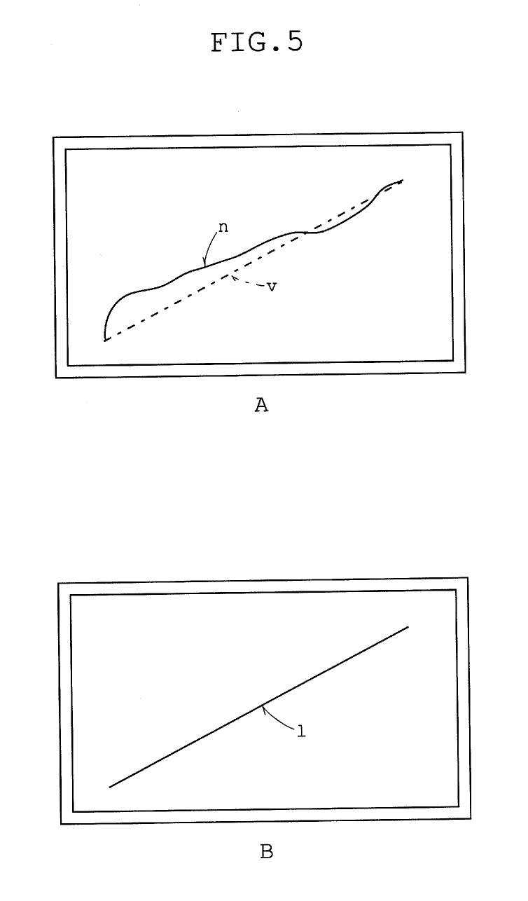

The free line forming unit 110 is configured to supply a signal indicative of the coordinate of the input position designated on the coordinate input screen 16 of the tablet 11, to the screen of the monitor 12, so that the input position is displayed on the monitor screen, as shown in FIG. 5A. When the coordinate input screen 16 is depressed by the stylus pen 15 and the stylus pen 15 is slid on the coordinate input screen 16, the free line forming unit 110 regards the sliding of the stylus pen 15 as the designation of a plurality of coordinates, forming a primary coordinate group composed of the plural coordinates aligned. The free line forming unit 110 connects the coordinates of the primary coordinate group together thereby to form a line. The line based on the primary coordinate group will hereinafter be referred to as “free line n.”

The straight line forming unit 120 forms a straight line 1, based on the free line n, as shown in FIG. 5B. The straight line forming unit 120 is configured to be capable of two-way communication with the straight line input assisting unit 130. As a result, the signals indicative of the free line n are transmitted from the straight line forming unit 120 to the straight line input assisting unit 130. Signals indicative of the straight line 1 formed by correcting or converting the signals indicative of the free line n are supplied from the straight line input assisting unit 130 to the straight line forming unit 120.

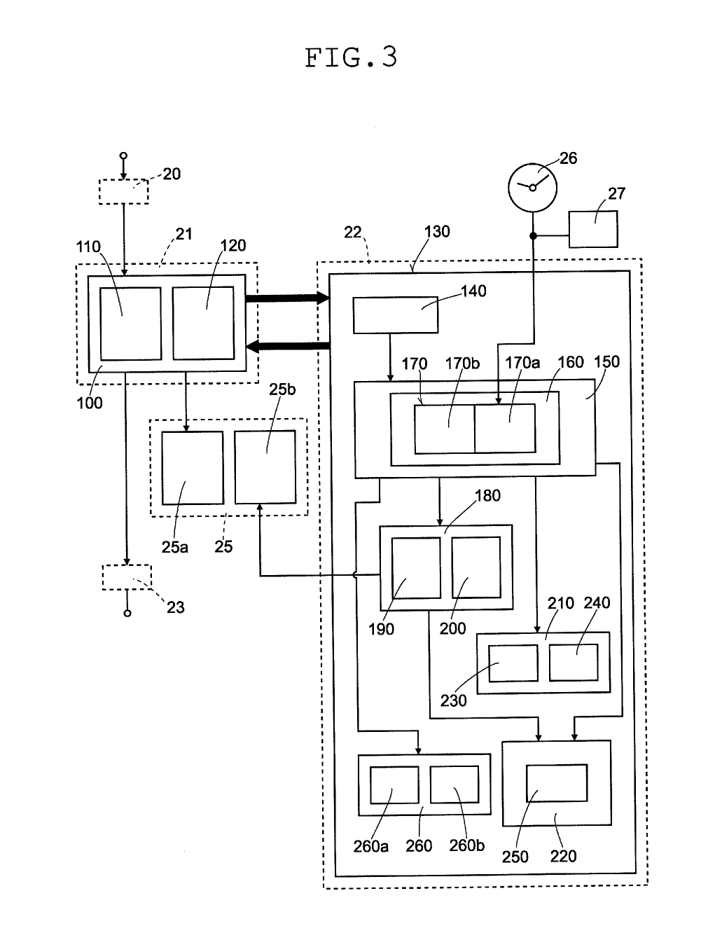

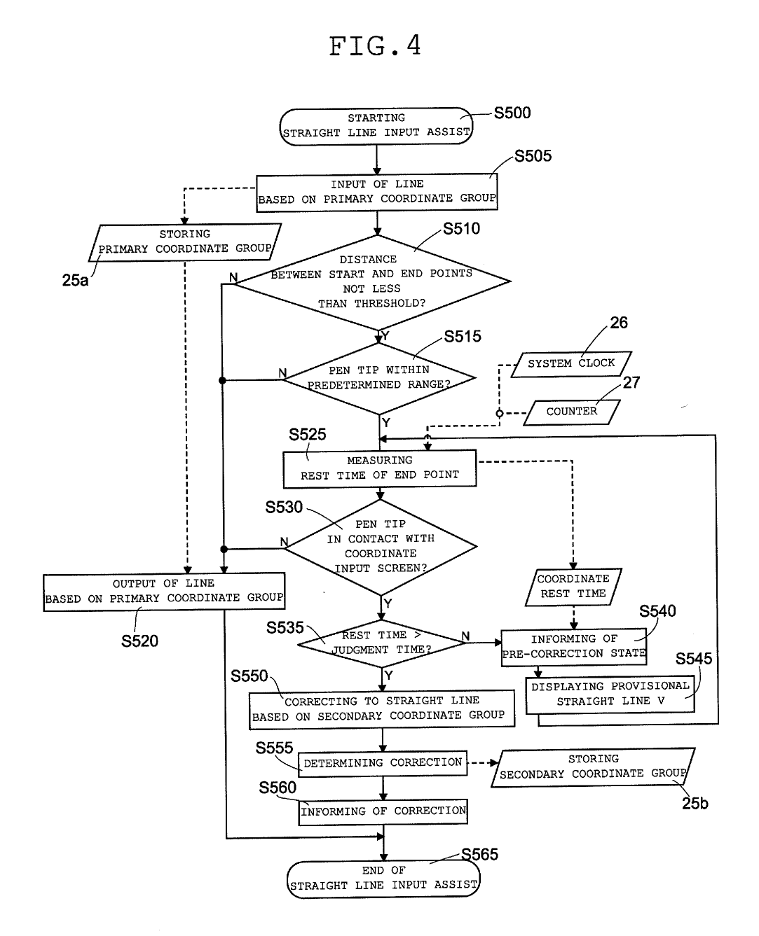

The straight line input assisting unit 130 is provided for automatically forming the straight line 1 as a subroutine, while the straight line forming unit 120 is in execution of the main routine of the drawing section 21, as shown in FIG. 3. Accordingly, when supplied with the signals indicative of the free line n based on the primary coordinate group from the straight line forming unit 120, the straight line input assisting unit 130 starts the processing to correct the signals (steps S500 and S505), as shown in FIG. 4. The straight line input assisting unit 130 determines correction to convert the signals supplied from the straight line forming unit 120 to the straight line 1 based on the secondary coordinate group (step S555). Corrected signals indicative of the straight line 1 are transmitted to the straight line forming unit 120. The straight line input assisting unit 130 then determines that assisting the straight line forming unit 120 has ended, thereby completing the processing to form the straight line 1 (step S565).

The straight line input assisting unit 130 includes a start point recognizing unit 140 and an end point determination unit 150 as shown in FIG. 3. The start point recognizing unit 140 is configured to recognize as a start point an input position initially depressed by the stylus pen 15 on the coordinate input screen 16 of the tablet 11. When the stylus pen 15 is slid on the coordinate input screen 16 after recognition of the start point while being kept depressed, the cursor is moved such that the free line n is drawn on the screen of the monitor 12 corresponding one-to-one with the coordinate input screen 16 as shown in FIG. 5A.

The end point determination unit 150 is configured to determine as an end point an input position where the stylus pen 15 has last been stopped on the coordinate input screen 16 of the table 11. Although an endpoint judging unit 160 is provided for automatically judging whether or not the input position is an end point, in the embodiment, as will be described later, the end point may be determined by a specific operation such as depressing a button provided on the stylus pen 15 or by thrusting down the pen tip of the stylus pen 15.

The start point recognizing unit 140 and the end point determination unit 150 execute the processing to determine whether or not the distance between the start point and the end point is equal to or longer than a predetermined distance or threshold regarding the free line n based on the input primary coordinate group, as shown in FIG. 4 (step S510). When determining that the distance between the start point and the end point is less than the threshold, the start point recognizing unit 140 and the endpoint determination unit 150 determine that the distance is within a range of error in the inputting, ending the straight line assisting (step S565) after having proceeded to step S520. When the distance is not less than the threshold, the start point recognizing unit 140 and the end point determination unit 150 proceed to signal processing for determination of the end point (step S515).

The end point determination unit 150 also includes the end point judging unit 160. The end point judging unit 160 is configured to judge whether or not an input point where the stylus pen 15 has been stopped on the coordinate input screen 16 of the tablet 11 is an end point. The judgment is carried out during the time when the stylus pen 15 is at rest while being depressed against the coordinate input screen 16. The end point judging unit 160 includes a timing unit 170a which measures a rest time and a comparison unit 170b which compares the measured rest time with a predetermined time.

The end point judging unit 160 executes the processing to judge whether or not the pen tip of the stylus pen 15 is within a predetermined range on the coordinate input screen 16, as shown in FIG. 4 (step S515). When the pen tip is out of the predetermined range, the end point judging unit 160 judges that the input position is not an end point, ending the straight input assisting after having proceeded to step S520 (step S565). When the pen tip is within the predetermined range, the end point judging unit 160 proceeds to the processing of signals relating to the timing unit 170a (step S525). As a result, slur of the pen tip depressing the coordinate input screen 16 is allowed within a predetermined range. Thus, an end point can be marked even if the pen tip is not completely stopped.

The timing unit 170a is synchronized with the clock built in the terminal device 13 and includes a system clock 26 measuring the time for the entire drawing system and a counter 27 counting a rest time of the stylus pen 15 at the end point. The timing unit 170a times a rest state of the cursor or measure a rest time of the stylus pen that is at rest at the position which has been regarded as the end point at step S515 (step S525).

The coordinate input unit of the tablet 11 generates a signal indicative of a coordinate of the input position when the tip of the stylus pen 15 is in contact with the coordinate input screen 16. On the other hand, when the tip of the stylus pen 15 has been moved away from the coordinate input screen 16, the coordinate input unit of the tablet 11 blocks the signals indicative of the coordinate of the input position supplied from the table 11, determining that the input operation has been canceled. Accordingly, the straight line input assisting unit 130 executes the processing to judge whether or not the input of the signals indicative of the coordinate of the input position is continued during measurement of the rest time of the stylus pen 15 (step S530). In other words, the straight line input assisting unit 130 executes the processing to judge whether or not the pen tip of the stylus pen 15 is in contact with the coordinate input screen 16. When the pen tip is in contact with the screen 16, the straight line input assisting unit 130 proceeds to the processing to compare the rest time with the predetermined judgment time by the comparison unit 170b (step S535). On the other hand, when the signals indicative of the coordinate of the input position has been blocked, the correction to convert the free line n to the straight line 1 based on the secondary coordinate group is canceled and the free line n is supplied (step S520).

The comparison unit 170b is configured to compare the rest time of the stylus pen 15 timed by the timing unit 170a with the predetermined judgment time or the threshold (step S535). As shown in FIG. 4, until the rest time exceeds the threshold, the pre-correction state informing unit 210 which will be described later informs that correction has not been executed (step S540) and processing to preview a provisional straight line v (step S545) is repeated. When the rest time has exceeded the threshold, the end point judging unit 160 judges that the input position where the stylus pen 15 has been stopped is the end point, proceeding to the processing to correct the signals in order that the provisional straight line v may be determined to be the straight line 1 (step S550). Consequently, the straight line input assisting unit 130 possesses the start point recognized by the start point recognizing unit 140 and the end point judged by the end point judging unit 160 and determined by the end point determining unit 150.

The straight line input assisting unit 130 further includes a coordinate aligning unit 180. The coordinate aligning unit 180 includes a distance measuring unit 190 which measures the distance between the start point and the end point, and a straight line setting unit 200 which sets the provisional straight line v so that the start point and the end point are connected by a single line in a straight through manner. The distance measuring unit 190 is configured to measure the distance between the start point and the end point in order that the start point and the end point may be connected by a shortest straight line. This drawing manner differs from step S510 where the processing to eliminate input errors resulting from the case where the start and end points as shown in FIG. 4 are too close to each other.

The measured shortest distance is set as a provisional straight line v by the straight line setting unit 200. The set provisional straight line is output during judgment of the rest time of the stylus pen 15 to be displayed on the screen of the monitor 12 (step S545). After determination of the end point (step S535), the coordinate aligning unit 180 carries out the signal correction processing to move and align the plural coordinates composing the free line n which is based on the primary coordinates and located between the start and end points (step S550), as shown in FIG. 4. Subsequently, the coordinate aligning unit 180 determines the processing to correct the signals indicative of the free line n based on the primary coordinate to signals indicative of straight line 1 based on the secondary coordinates (step S555). As a result, the free line n is corrected to the straight line 1. The provisional straight line v which has been previewed together with the free line n as shown in FIG. 5A is re-drawn to the straight line 1 on the screen of the monitor 12 as shown in FIG. 5B.

The processing to determine the signal correction (step S555) is determined after the endpoint determining unit 150 has determined that the candidate end point judged by the end point judging unit 160 is an end point. Accordingly, the provisional straight line v set by the straight line setting unit 200 is displayed on the screen of the monitor 12 while the end point judging unit 160 is judging the end point (step S535). The provisional straight line v is determined to be the straight line 1 only upon determination of the end point (step S555). Accordingly, when the tip of the stylus pen 15 is moved away from the coordinate input screen 16 while the provisional straight line v is being displayed, the input operation is stopped (step S530) or the pen tip can be displaced out of a predetermined region (step S515), whereby the provisional straight line v can be canceled and the free line n can be displayed or a new straight line can be re-drawn (S500).

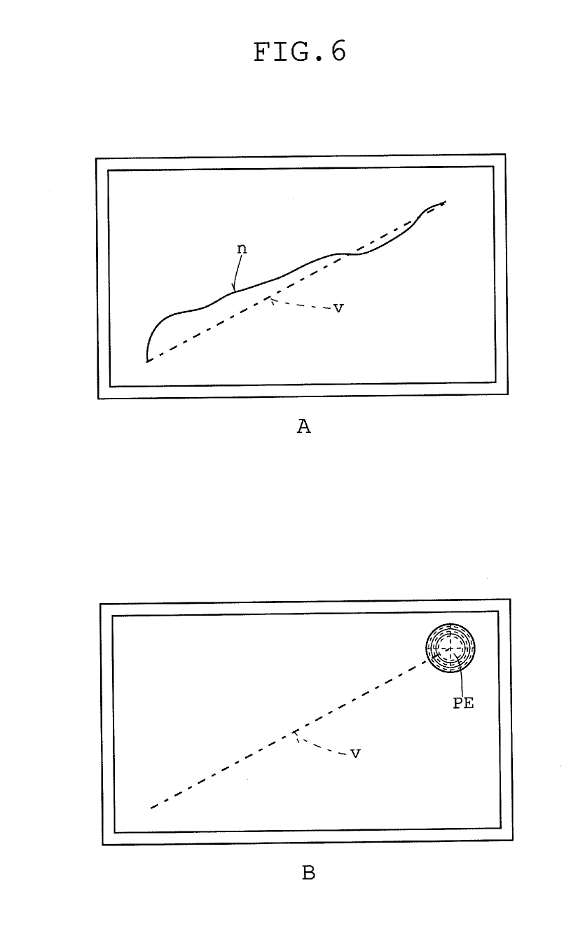

As described above, the free line n is automatically corrected to the straight line 1 when the input position where the stylus pen 15 has been stopped on the coordinate input screen 16 is determined to be the end point after lapse of a predetermined time. In this case, since there is a case where the user does not desire correction, the straight line input assisting unit 130 includes a pre-correction state informing unit 210 which informs that the provisional straight line v will be corrected to the straight line 1 and a post-correction state informing unit 220 which informs that the free line n has already been corrected to the straight line 1. The pre-correction state informing unit 210 is configured to inform the user of the correction to be executed, before the free line n is corrected to the straight line 1, as shown in FIG. 6. The pre-correction state informing unit 210 includes a previewing unit 230 and pre-correction visual effect producing unit 240.

The previewing unit 230 executes the processing of signals relating to the pre-correction state informing unit 210 (step S540) and the processing of signals so that the provisional straight line v can be displayed on the screen of the monitor 12 (step S545) as shown in FIG. 4. As a result, the provisional straight line v formed by the straight line setting unit 200 can be output via the drawing section 21 and the output section 23 thereby to be displayed on the monitor 12.

The previewing may include simultaneously displaying the free line n and the provisional straight line v together or displaying only the provisional straight line v as shown in FIG. 6A. The pre-correction visual effect producing unit 240 is configured to display an icon PE flashing near the end point of the provisional straight line v previewed before determination of the straight line 1 by the coordinate aligning unit 180 or during the judgment of the end point, as shown in FIG.6B. The icon PE is displayed to produce a visual effect such as flashing, oscillation and color change in cooperation with the counter 27 of the end point judging unit 160. As a result, the conversion of the free line n to the straight line 1 can be informed before end of correction with the determination of the input location of the coordinate indicative of the end pint.

Furthermore, countdown by the counter 27 may be displayed in numerals using the icon PE. Since this can inform of a rough time required for the coordinate movement to be determined, the user can obtain a time to select the free line n or correction to the straight line 1. The determination of the end point is canceled when the stylus pen 15 is further moved or the tip of the stylus pen 15 is moved away from the coordinate input screen of the tablet 11 before the determination of coordinate movement or during the judgment of the end point by the end point judging unit 160. This can avoid the determination of input position of the coordinate indicative of the end point.

Furthermore, the provisional straight line v may be flashed or oscillated by the pre-correction visual effect producing unit 240. Still furthermore, a predetermined melody can be produced from a loudspeaker (not shown) provided in the terminal device 13.

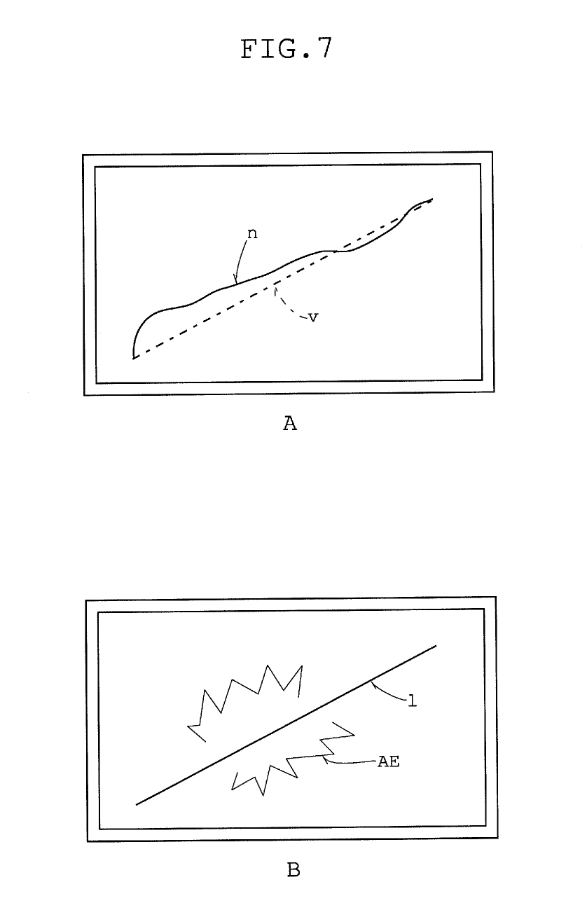

The post-correction state informing unit 220 executes the processing to inform of completion of the correction after the straight line 1 has been determined at step S150 as shown in FIG. 4 (step S560). The post-correction state informing unit 220 is further configured to inform the user that the correction has been made, after correction of the free line n to the straight line 1, as shown in FIG.7B.

The post-correction state informing unit 220 includes a post-correction visual effect producing unit 250. The post-correction state informing unit 220 is configured to give a visual effect AE to the straight line 1 displayed on the monitor 12 when or after the straight line 1 has been determined by the coordinate aligning unit 180 or the endpoint has been determined by the end point determining unit 150. The visual effect AE is adapted to change the color of the straight line, to flash the straight line or the whole screen of the monitor 12. Furthermore, a predetermined bell sound or buzzer sound may be produced from the loudspeaker (not shown) provided in the terminal device 13.

A cancel icon to cancel the correction to the straight line 1 may be displayed near the end point of the straight line 1. As a result, the input position of the coordinate indicative of the end point is determined and the automatic correction of the free line v to the straight line 1 can be canceled such that the straight line 1 can be returned to the free line n. The visual effect AE should not be limited to the above-described special effect but the setting of the visual effect may optionally be changed by a program or the like.

Consequently, since the correction of the free line n to the straight line 1 is informed of, the user can easily understand that the free line n drawn by the user has been corrected to the straight line 1.

The straight line input assisting unit 130 is configured to automatically correct the free line n to the straight line 1. Furthermore, the straight line input assisting unit 130 includes a line type selecting unit 260 which can select a line other than the solid straight line. The line type includes solid line, double line, wavy line, dot line, broken line, chained line and a line whose line thickness is gradually changed.

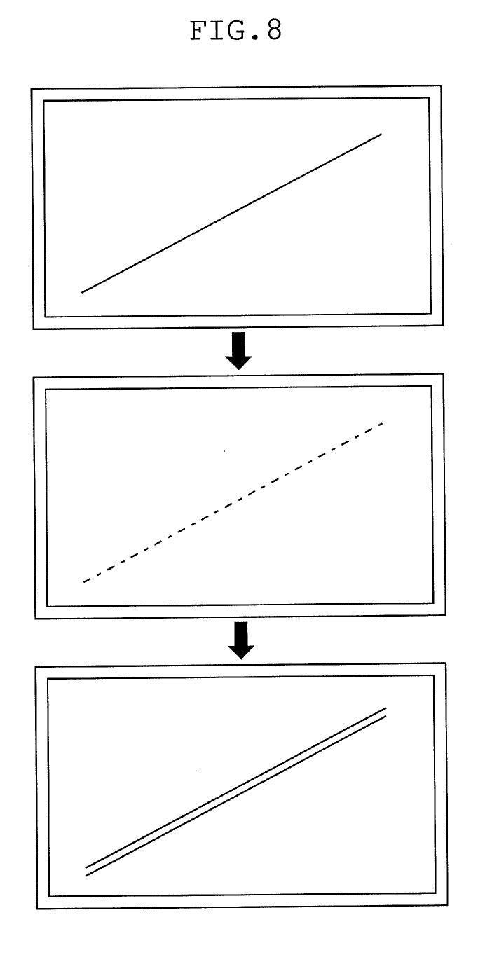

The line type selecting unit 260 includes a time series dependence unit 260a and an input dependence unit 260b. The time series dependence unit 260a shows a state where the line type is corrected in one after another when the rest time of the stylus pen 15 has been timed and the end point has been judged and thereafter, the stylus pen 15 has been stopped, as shown in FIG. 8. As the result of provision of the time series dependence unit 26a, a predetermined line type can freely be selected according to the time when the stylus pen is moved away from the coordinate input screen of the stylus pen 15. In this case, in the signal processing for line type selection, the rest time of the stylus pen 15 is measured (step S525) as shown in FIG. 4. This processing is carried out in parallel to the processing to determine whether or not the rest time has exceeded the threshold (step S535). When the time series dependence unit 260a is set, the processing (step S530) of canceling the correction processing in the case of departure of the pen tip from the coordinate input screen 16 is not carried out at step S520 where the free line n is output, but instead, the processing to cite a predetermined line type by the previewing unit 210 according to the time from the contact of the stylus pen 15 with the coordinate input screen 16 to the leave of the stylus pen 15 from the coordinate input screen 16. The previewing unit 210 replaces the provisional line v with a predetermined line type, which type is displayed on the screen of the monitor 12.

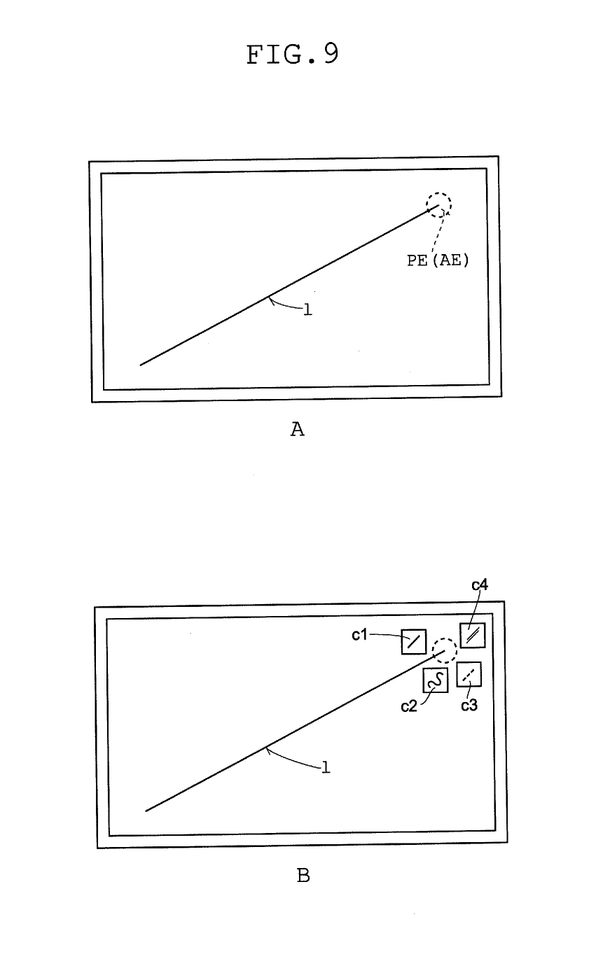

Furthermore, the time series dependence unit 260a may be configured to change the line type on the basis of the straight line 1 after the correction of converting the free line n to the straight line 1 has been determined (step S555), as shown in FIGS. 9A and 9B. FIG. 9B shows the case where a plurality of icons c1, c2, c3 and c4 regarding the line type selecting menu is displayed in the vicinity of the end point of the straight line 1, after the end point has been determined by the end point determining unit 150.

When one of the icons c1 to c4 indicative of a desired line type is designated on the coordinate input screen 16 by the stylus pen 15, the line type can be converted to the designated one. The icons c1 to c4 of the line type selection menu may be displayed during the end point judgment by the end point judging unit 160 before the correction is determined.

The input dependence unit 260b is configured to depend on the mode in the case where the input position is designated on the coordinate input screen 16. More specifically, a pressure sensitive switch is provided in the tablet 11 for detecting the difference in the pressing force of the stylus pen 15 applied to the coordinate input screen 16 or the difference in a tilt of the pen tip 15a of the stylus pen 15, whereby the line type can freely be selected on the basis of the difference in the input state.

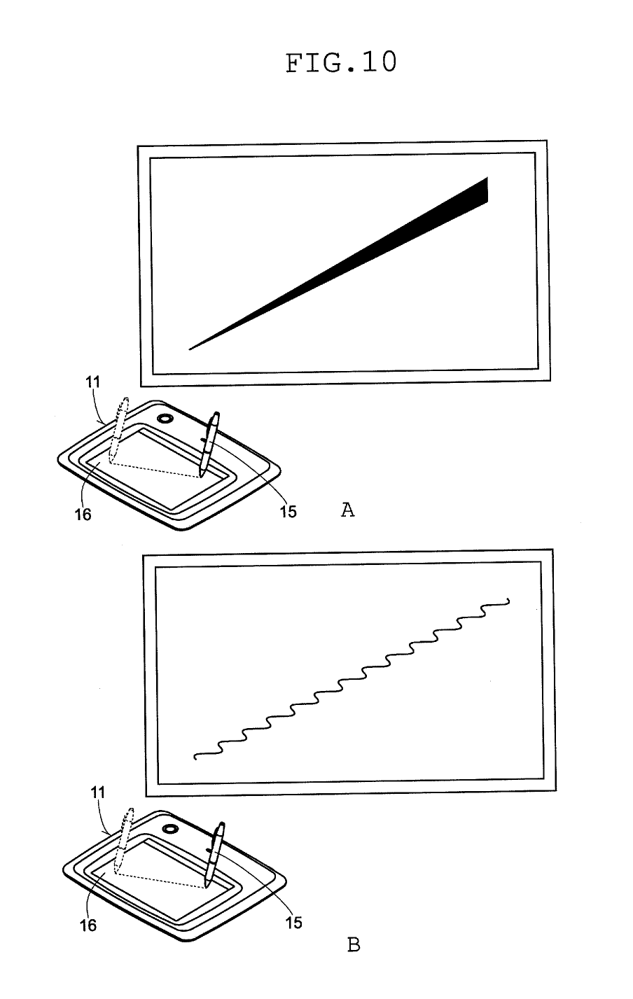

FIG. 10A shows a case where the thickness of the straight line 1 is gradually increased on the screen of the monitor 12 when the pressing force at the input position of the end point is larger than the input position of the start point. Furthermore, FIG. 10B shows a case where the straight line 1 output by the straight line forming unit 120 is displayed as a wavy line on the screen of the monitor 12.

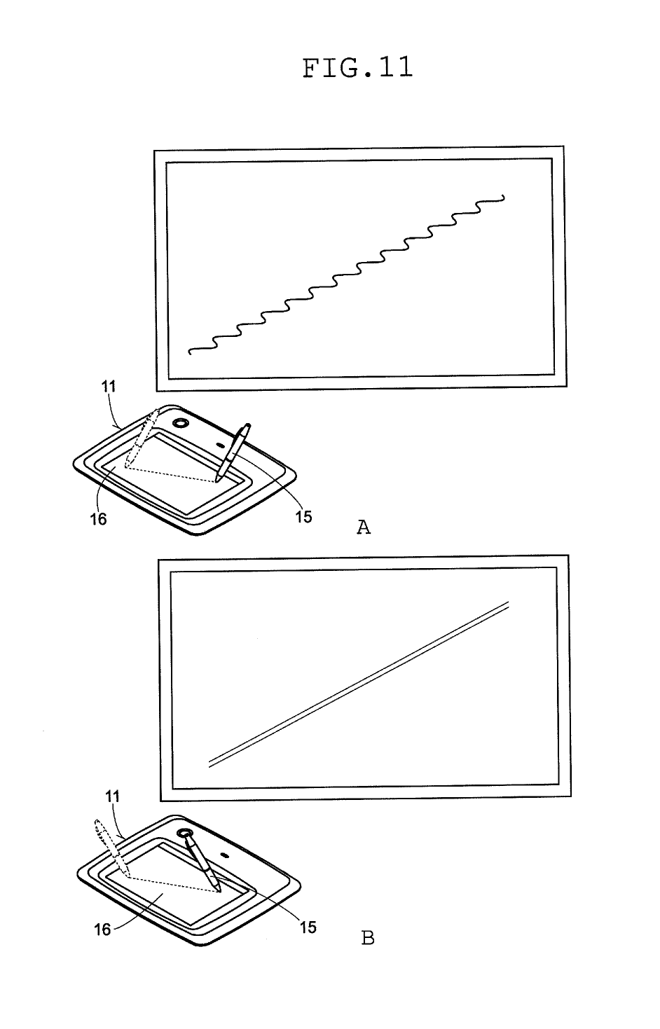

FIG. 11A shows a case where the straight line 1 output from the straight line forming unit is displayed as a wavy line on the screen of the monitor 12 when the pen tip is tilted rightward. FIG. 11B shows a case where the straight line 1 is displayed as a double line on the screen of the monitor 12 when the pen tip is tilted leftward.

Since various line types can be selected and designated depending on operation of the stylus pen 15 as described above, the user can easily select a desirable line type. Furthermore, a line type selecting unit 260 may be configured by properly combining the above-described time series dependence unit 260a and the input dependence unit 260b together. In this case, for example, when the pen tip is pressed against the coordinate input screen of the tablet 11 while being tilted rightward, the line type of the straight line 1 may sequentially be changed according to a pressing time. The line type may be changed to the last one when the pen tip is tilted leftward.

According to the line type selecting unit 260, furthermore, the straight line 1 is formed by the coordinate aligning unit 180 and thereafter, the line type is selected on the basis of the formed straight line 1. Accordingly, for example, the spacing between double lines can be equalized, and the spacing between adjacent dot lines, chain lines or broken lines can be equalized. Amplitude and wavelength can be equalized in the case of wavy lines. As a result, clearer lines can be displayed on the screen of the monitor 12 as compared with the case where lines are drawn freehand.

According to the above-described drawing system 10, regarding the free line n based on the input primary coordinate group comprising a plurality of coordinates, the start point thereof is automatically recognized and the end point is automatically determined. Furthermore, a plurality of coordinates located between the start and end points is automatically aligned thereby to be formed into the secondary coordinate group. The free line n is automatically corrected or converted to the straight line 1 based on the secondary coordinate group. Consequently, since the straight line that is hard to draw freehand can easily be drawn, the usability of the drawing system can be improved.

Furthermore, in the automatic correction of the free line n to the straight line 1 or after the correction, the correction is informed of by the icon PE producing the visual effect AE near the end point of the straight line 1 or the visual effect AE added to the straight line 1. Consequently, the user can easily recognize that the drawn free line n is corrected to the straight line 1.

Furthermore, since various lines can be selected on the basis of the straight line 1, the user can display a desirable line on the screen of the monitor 12 without a specific operation.

Although the tablet 11 and the stylus pen 15 are used in the foregoing embodiment, another pointing device typified by a mouse may be used in the drawing.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

1. A drawing system comprising:
a monitor;
a pointing device including a coordinate input unit which designates an input position or a coordinate on a screen of the monitor or moves a cursor displayed on the monitor screen to an optional position;
a control unit which controls the pointing device and the cursor so that a moving distance and a direction of the pointing device and a moving distance and a direction of the cursor are associated with each other;
a drawing unit which draws a line of a trajectory of the cursor on the monitor screen, based on a group of primary coordinates formed by aligning a plurality of coordinates continuously input by the coordinate input unit, wherein:
the drawing unit includes a straight line input assisting unit which corrects a line formed based on the primary coordinate group to a straight line;
the straight line input assisting unit includes a start point recognizing unit, an end point determination unit and a coordinate aligning unit;
the start point recognizing unit recognizes as a start point an initial coordinate having an input position designated by the coordinate input unit;
the end point determination unit determines as an end point a last coordinate having an input position designated by the coordinate input unit;
the coordinate aligning unit aligns the coordinates of the primary coordinate group on a single line connecting between the start point and the end point thereby to form a secondary coordinate group; and
when a line is drawn by the drawing unit based on the primary coordinate group, the line is corrected to a straight line based on the secondary coordinate group.

2. The drawing system according to claim 1, wherein:
the end point determination unit includes an end point judging unit which judges whether or not an input position designated by the coordinate input unit is an end point;
the end point judging unit includes a timing unit which times a rest state of the cursor displayed at the input position designated by the coordinate input unit and a comparison unit which compares a rest time of the cursor obtained by the timing unit with a threshold, the end point judging unit judging the input position to be the end point when the rest time has exceeded the threshold.

3. The drawing system according to claim 1, wherein the straight line input assisting unit includes a pre-correction state informing unit which informs that correction is to be executed, before the coordinate aligning unit corrects the line based on the primary coordinate group to the straight line based on the secondary coordinate group.

4. The drawing system according to claim 2, wherein the straight line input assisting unit includes a pre-correction state informing unit which informs that correction is to be executed, before the coordinate aligning unit corrects the line based on the primary coordinate group to the straight line based on the secondary coordinate group.

5. The drawing system according to claim 1, wherein the straight line input assisting unit includes a post-correction state informing unit which informs that correction is to be executed, after the coordinate aligning unit has corrected the line based on the primary coordinate group to the straight line based on the secondary coordinate group.

6. The drawing system according to claim 2, wherein the straight line input assisting unit includes a post-correction state informing unit which informs that correction is to be executed, after the coordinate aligning unit has corrected the line based on the primary coordinate group to the straight line based on the secondary coordinate group.

7. The drawing system according to claim 3, wherein the straight line input assisting unit includes a post-correction state informing unit which informs that correction is to be executed, after the coordinate aligning unit has corrected the line based on the primary coordinate group to the straight line based on the secondary coordinate group.

8. The drawing system according to claim 4, wherein the straight line input assisting unit includes a post-correction state informing unit which informs that correction is to be executed, after the coordinate aligning unit has corrected the line based on the primary coordinate group to the straight line based on the secondary coordinate group.

9. The drawing system according to claim 1, wherein the straight line input assisting unit includes a line type selecting unit which renders a type of a line to be displayed on the monitor screen selectable before or after correction of the line based on the primary coordinate group to the straight line based on the secondary coordinate group by the coordinate aligning unit.

10. The drawing system according to claim 2, wherein the straight line input assisting unit includes a line type selecting unit which renders a type of a line to be displayed on the monitor screen selectable before or after correction of the line based on the primary coordinate group to the straight line based on the secondary coordinate group by the coordinate aligning unit.

11. The drawing system according to claim 3, wherein the straight line input assisting unit includes a line type selecting unit which renders a type of a line to be displayed on the monitor screen selectable before or after correction of the line based on the primary coordinate group to the straight line based on the secondary coordinate group by the coordinate aligning unit.

12. The drawing system according to claim 4, wherein the straight line input assisting unit includes a line type selecting unit which renders a type of a line to be displayed on the monitor screen selectable before or after correction of the line based on the primary coordinate group to the straight line based on the secondary coordinate group by the coordinate aligning unit.

13. The drawing system according to claim 5, wherein the straight line input assisting unit includes a line type selecting unit which renders a type of a line to be displayed on the monitor screen selectable before or after correction of the line based on the primary coordinate group to the straight line based on the secondary coordinate group by the coordinate aligning unit.

14. The drawing system according to claim 6, wherein the straight line input assisting unit includes a line type selecting unit which renders a type of a line to be displayed on the monitor screen selectable before or after correction of the line based on the primary coordinate group to the straight line based on the secondary coordinate group by the coordinate aligning unit.

15. The drawing system according to claim 7, wherein the straight line input assisting unit includes a line type selecting unit which renders a type of a line to be displayed on the monitor screen selectable before or after correction of the line based on the primary coordinate group to the straight line based on the secondary coordinate group by the coordinate aligning unit.

16. The drawing system according to claim 8, wherein the straight line input assisting unit includes a line type selecting unit which renders a type of a line to be displayed on the monitor screen selectable before or after correction of the line based on the primary coordinate group to the straight line based on the secondary coordinate group by the coordinate aligning unit.
